(19) United States
(12) Patent Application Publication
(10) Pub. No.: US 2026/0043109 A1
(43) Pub. Date: Feb. 12, 2026

(54) GAS HYDRATE-BASED LITHIUM PROCESSING FROM BRINE

(71) Applicant: SAUDI ARABIAN OIL COMPANY, Dhahran (SA)

(72) Inventors: Pramod Dhanaji PATIL, Dhahran (SA); Abdulaziz S. AL-QASIM, Dhahran (SA); Klemens KATTERBAUER, Dhahran (SA); Ali A. YOUSEF, Dhahran (SA)

(73) Assignee: SAUDI ARABIAN OIL COMPANY, Dhahran (SA)

(21) Appl. No.: 18/799,786

(22) Filed: Aug. 9, 2024

(51) Int. Cl. C22B 3/44; C22B 26/12

(52) U.S. Cl. CPC C22B 3/44; C22B 26/12

(57) ABSTRACT

Methods for concentrating brine comprising: introducing an input brine to a first hydrate column, wherein the input brine comprises a lithium ion and water; introducing an input gas to the input brine within the first hydrate column; forming a gas hydrate with the water and the gas; concentrating the input brine, due to formation of the gas hydrate with the water, to form a concentrated brine; and extracting, from the first hydrate column, the concentrated brine.

### FIELD OF THE DISCLOSURE

The present disclosure relates generally to lithium brine processing and, more particularly, to gas hydrate-based lithium processing from brine.

### BACKGROUND OF THE DISCLOSURE

Lithium and ions thereof are critical materials increasingly needed in energy storage (e.g., battery) manufacturing. As demand for batteries has increased, lithium has become increasingly important for global energy supply chains.

Lithium can generally be derived either from brines or ores. In some locations, lithium-containing ore may be mined and processed to extract lithium metals. In some locations, extraction of lithium from a brine may be preferred, in particular if natural formations of lithium brine are extant within a surface reservoir and/or subterranean fluid reservoir. Lithium can be extracted from a brine through various methods. Many conventional processes of lithium extraction from brine may be carbon-intensive, requiring concentration and subsequently direct extraction (e.g., adsorption, electrolysis, and/or membrane-based extraction).

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

A first nonlimiting example method of the present disclosure may include: introducing an input brine to a first hydrate column, wherein the input brine comprises a lithium ion and water; introducing an input gas to the input brine within the first hydrate column; forming a gas hydrate with the water and the gas; concentrating the input brine, due to formation of the gas hydrate with the water, to form a concentrated brine; and extracting, from the first hydrate column, the concentrated brine.

A second nonlimiting example method of the present disclosure may include: introducing an input brine to a first hydrate column, wherein the input brine comprises a lithium ion and water; introducing a input gas to the input brine within the hydrate column; forming a gas hydrate with the water and the gas; concentrating the input brine, due to formation of the gas hydrate with the water, to form a concentrated brine; extracting, from the first hydrate column, the concentrated brine; lowering the pressure to less than 5 bar after formation of the gas hydrate; and decomposing the gas hydrate to form remaining water and remaining gas.

A third nonlimiting example method of the present disclosure may include: introducing an input brine to a first hydrate column, wherein the first hydrate column comprises a bubble column, wherein the input brine comprises a lithium ion and water, and wherein introducing the input gas occurs at a pressure of about 30 bar (435.11 psi) to about 42.5 bar (616.4 psi) and at a temperature of about 5° C. to about 15° C.; introducing a input gas to the input brine within the first hydrate column, wherein the input gas comprises carbon dioxide; forming a gas hydrate with the water and the gas; concentrating the input brine, due to formation of the gas hydrate with the water, to form a concentrated brine; extracting, from the first hydrate column, the concentrated brine; lowering the pressure to less than 5 bar after formation of the gas hydrate; and decomposing the gas hydrate to form remaining water and remaining gas.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a diagram of a nonlimiting example system according to the present disclosure.

FIG. 2 is a diagram of a nonlimiting example system according to the present disclosure.

FIG. 3 is a diagram of a nonlimiting example hydrate column according to the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to lithium brine processing and, more particularly, to gas hydrate-based lithium processing from brine.

The present disclosure allows for concentration of lithium brine using a gas hydrate column. Within the gas hydrate column, gas is introduced at elevated pressure and reduced temperature (as compared to atmospheric conditions). Under such conditions, hydrates with water of brine form using water from brine, thus concentrating lithium brine allowing for increased efficiency and/or increased process intensification of overall production of lithium products. Furthermore, processes of the present disclosure may allow for reduced carbon dioxide emissions due to lower utility (e.g., heating) need as compared to conventional lithium concentration processes.

Methods of the present disclosure include introducing an input brine comprising a lithium ion and an aqueous fluid to a hydrate column (e.g., a first hydrate column), introducing a gas, preferably comprising carbon dioxide, to input brine within the hydrate column, and forming a gas hydrate with the aqueous fluid and the gas, thereby concentrating the input brine to form a concentrated brine. Methods may further include extracting, from the first hydrate column, the concentrated brine.

Methods of the present disclosure may further include lowering pressure (i.e., depressurization) within the hydrate column after formation of the gas hydrate. Depressurization may include setting pressure of a column to less than about 5 bar, about 0.1 bar to about 5 bar, about 0.5 bar to about 5 bar, or about 1 bar to about 5 bar. Depressurization may include setting temperature of a column to about −10 °C. to about 10° C., about 0° C. to about 10° C., about −5° C. to about 5° C., or about −10 °C. to about 0° C. The pressure and temperature may be adjusted based on the method and desired gas hydrates.

Methods of the present disclosure may include extracting a first majority of remaining gas from the first hydrate column. Methods of the present disclosure may further include recycling a first majority of the remaining gas from the first hydrate column to a second hydrate column. Furthermore, liquid water may be removed from gas hydrates of the present disclosure during depressurization of a hydrate column. Liquid water may be removed through an outlet or any other suitable mechanism.

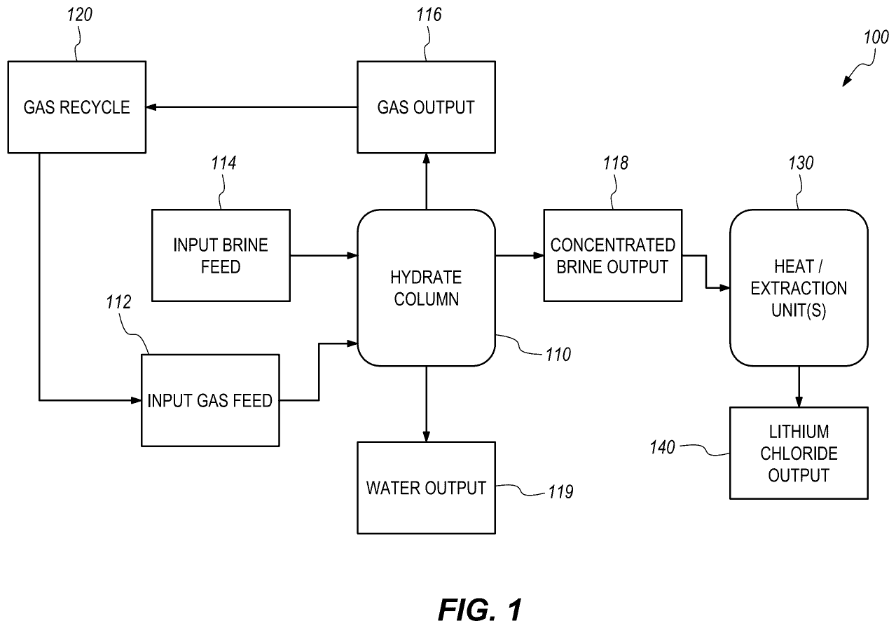

A nonlimiting example system of the present disclosure is shown in FIG. 1. System 100 includes hydrate column 110, which receives input gas feed 112 comprising input gas and input brine feed 114 comprising input brine. Within hydrate column 110, input gas from input gas feed 112 interacts with input brine of input brine feed 114 to facilitate the formation of gas hydrates from input gas and water within input brine as described in the present disclosure. After formation of gas hydrates, concentrated brine may be formed and released through concentrated brine output 118. Upon pressure release (e.g., depressurization), remaining gas may be released from hydrate column 110 through gas output 116. Remaining gas directed through gas output 116 may subsequently be directed through gas recycle 120 and subsequently directed back to input gas feed 112 for recycling. Concentrated brine passed to concentrated brine output 118 may further be processed through heat and extraction unit(s) 130. Such heat and extraction unit(s) 130 may further purify or otherwise process concentrated brine, ultimately producing lithium product through a lithium product output 140 comprising lithium ions (e.g., lithium chloride). During a depressurization cycle liquid water (e.g., remaining water) may be extracted from gas hydrates formed in hydrate column 110 (after removal of concentrated brine). Such liquid water may be removed through water output 119.

Input gas may be introduced to the hydrate column at any suitable location. Preferably, gas may be introduced in a bottom-region of the hydrate column. “Bottom-region” as used herein, refers to a region of space in the lowest 25%, lowest 15%, lowest 10%, or lowest 5% of height of the hydrate column. “Height” of a column, as used herein, refers to vertical distance measured from a bottom of an interior of a column to a top of an interior of a column. Height may include all vertical distance in one or more vessels included in a column (i.e., a column having more than one vessel may have a height inclusive of all vessel heights included therein, not including any connective conduits between vessels of a single column). Input gas may be introduced at a pressure of about 30 bar to about 50 bar, or about 30 bar to about 42.5 bar, or about 30 bar to about 35 bar, or about 35 bar to about 42.5 bar and at a temperature of about 2.5° C. to about 20° C., or about 5° C. to about 15° C., or about 7° C. to about 12° C.

Input gas of the present disclosure may comprise any gas suitable for forming hydrates with water. Input gasses of the present disclosure may comprise or consist essentially of, carbon dioxide (CO₂), methane (CH₄), the like, or any combination thereof.

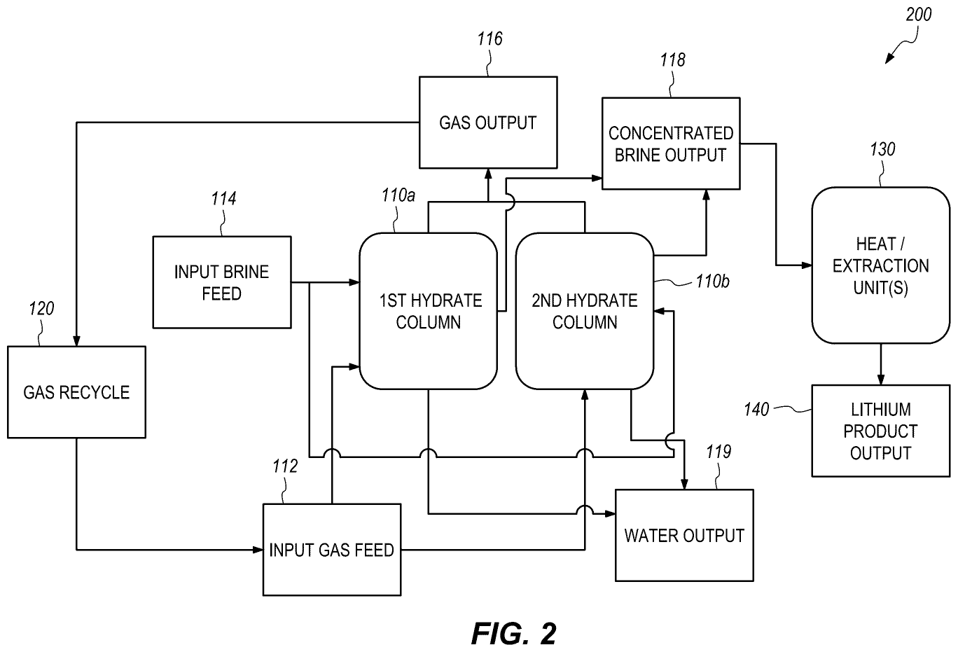

Furthermore, methods of the present disclosure may include use of more than one gas hydrate column. A nonlimiting example system of the present disclosure is shown in FIG. 2. System 200 includes 1^{st} gas hydrate column 110a and 2^{nd} hydrate column 110b, which receive input gas feed 112 comprising input gas and input brine feed 114 comprising input brine. Within hydrate columns 110a and 110b, input gas from input gas feed 112 interacts with input brine of input brine feed 114 to facilitate the formation of gas hydrates from input gas and water within input brine as described in the present disclosure. After formation of gas hydrates, concentrated brine may be formed and released through concentrated brine output 118. Upon pressure release (e.g., depressurization), remaining gas may be released through gas output 116 from the hydrate column. Remaining gas directed through gas output 116 may subsequently be directed through gas recycle 120 and subsequently directed back to input gas feed 112 for recycling in either column 110a or 110b or both.

Hydrate columns 110a and 110b may operate on a staggered basis, such that a 1^{st} hydrate column 110a enters pressurization and engages in formation of concentrated brine while the 2^{nd} hydrate column simultaneously is in depressurization and engages in removal of water from gas hydrates. Subsequently, columns may reverse roles. Such staggering may allow for reduction in need for utilities and materials including, but not limited to, for example, reduced gas need, reduced water usage, the like, or any combination thereof.

Concentrated brine from hydrate columns 110a, 110b may pass to passed to concentrated brine output 118, and may further be processed through heat and extraction unit(s) 130. Such heat and extraction unit(s) 130 may further purify or otherwise process concentrated brine, ultimately producing lithium product through a lithium product output 140 comprising lithium ions (e.g., lithium chloride). During a depressurization cycle liquid water (e.g., remaining water) may be extracted from gas hydrates formed in hydrate column 110 (after removal of concentrated brine. Such liquid water may be removed through water output 119.

As discussed herein, gas hydrates may form within columns (e.g., hydrate columns) of the present disclosure. Gas hydrates may enable water to be removed from aqueous solution, thus increasing concentration of lithium ions in input brine to form concentrated brine. Furthermore, gas hydrates may comprise carbon dioxide and water, such as, for example, hydrates having a formula of CO₂·ₙH₂O, or methane and water, having a formula of CH₄·ₙH₂O, where n may equal from about 5.8 to about 6.3, about 5.8 to about 6.0, or about 6.0 to about 6.3.

Input brine of the present disclosure may comprise or consist essentially of a lithium-containing brine including lithium ions dispersed (e.g., at least partially dissolved, fully dissolved, the like) within an aqueous fluid. Input brine may have a lithium concentration of about 5 ppm to about 1,400 ppm by weight. Lithium ions of interest may include, but are not limited to, lithium chloride, lithium carbonate, lithium hydroxide, lithium bromide, or the like.

Input brine of the present disclosure may generally originate from any suitable source. For example, input brine may be derived from a hydrocarbon extraction operation (e.g., a hydrocarbon well, a shale formation, the like) . In another example, input brine may be derived from a geothermal well.

Concentrated brines may be formed from input brine that has had a portion of liquid water (H₂O) removed out of aqueous fluid due to formation of gas hydrates and precipitation thereof out of solution as described herein. Concentrated brines may have a lithium ion concentration of about 10 ppm to about 8,500 ppm by weight. Concentrated brines may have a lithium ion concentration from about 3× (times) to about 6×0 more, or about 4× to about 6× more, or about 5× more, or greater than 5× more concentrated than input brine. As a nonlimiting example, if an input brine has a lithium ion concentration of about 5 ppm by weight, corresponding concentrated brine may have a lithium ion concentration of about 15 ppm to about 30 ppm by weight, or about 20 ppm to about 30 ppm by weight, or about 25 ppm by weight, or greater than about 25 ppm by weight. Concentrated brines of the present disclosure may include a variety of dissolved ions including those of input brines of the present disclosure.

Hydrate columns of the present disclosure may operate at any suitable pressure and temperature as described above. Hydrate columns of the present disclosure may comprise modified bubble columns. Suitable hydrate columns may have 1 or more, or 10 or more trays. The hydrate columns may include at least one sparger, and the sparger may be a porous plate, ring sparger, or needle sparger.

Hydrate columns of the present disclosure may have a diameter to length ratio of about 0.01 to about 3.0, or about 0.01 to about 2.0, or about 0.01 to about 1.0, or about 0.1 to about 1.0, or about 0.5 to about 2.0, or about 0.1 to about 4.0, or about 0.2 to about 1.0. Hydrate columns of the present disclosure may have an increased cross-sectional area as compared to conventional columns, so as to allow for increased reaction area for gas hydrate formation.

Hydrate columns of the present disclosure may employ additional components known in the art for operating chemical processes and systems. One of ordinary skill in the art will be able to, with the benefit of the present disclosure, operate a hydrate column using said additional components. Such additional components may serve a variety of functions and may include, but are not limited to, for example, valves, valve actuators, sensors (e.g., temperature sensors, pressure sensors, level sensors, fiber-optic sensors, salinity sensors, the like, or any combination thereof), heat exchangers, the like, or any combination thereof. As a nonlimiting example, additional components may be used to maintain a maximum fluid level within hydrate columns of the present disclosure. The maximum fluid level in a hydrate column may be set to a specific value or range.

The maximum fluid level within hydrate columns may be measured by one or more level sensors. Level sensors may be ultrasonic, radar, or float-type sensors that provide real-time measurements of the fluid level within the column. Sensors of use in the present disclosure may include salinity sensors. Sensors may be positioned on or affixed to input brine feed line(s) so as to measure input brine salinity and/or may be positioned on or affixed to concentrated brine output line(s) so as to measure concentrated brine salinity. Sensors may be positioned within hydrate columns of the present disclosure. Sensors of use in the present disclosure may include but are not limited to, a fiber-gratings (FBG) device. An FBG may be used in accordance with the present disclosure to measure salinity, temperature, and the like.

The sensors may communicate with a control system, and the control system may, in real time, adjust a fluid level in the hydrate column based on the sensor. The control system may adjust the fluid level in the hydrate column by adjusting the flow rates of incoming and/or outgoing streams including input gas feed 112, input brine feed 114, gas output 116, concentrated brine output 118, or water output 119. The control system may adjust also adjust the pressure and temperature of the input gas introduced into the hydrate columns. The control system may include advanced algorithms, computational fluid dynamics (CFD), artificial intelligence (AI), neural networks, fuzzy logic, the like, or combinations thereof to determine the optimal flow rates, pressure, or temperature of incoming and/or outgoing streams of the hydrate columns.

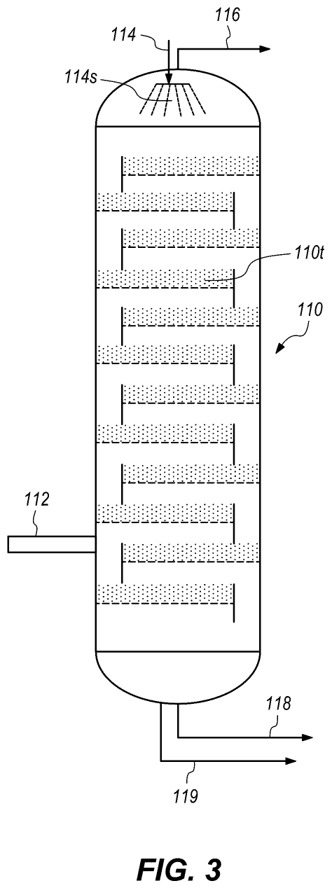

A nonlimiting example side view diagram of a hydrate column is shown in FIG. 3. Hydrate column 110 includes a plurality of trays 110t, increasing available surface area for formation of gas hydrates and thus formation of concentrated brine. Generally, hydrate column 110 may include an input gas feed 112, an input brine feed 114, a gas output 116, a concentrated brine output 118, and water outlet 119. In various embodiment of the present disclosure input brine 114 may be fed through an input brine distributor 114s. Input brine distributor 114s may serve to disperse input brine throughout hydrate column 110. An input brine distributor of the present disclosure may generally comprise any suitable apparatus for fluid distribution including a sprayer, an atomizer, the like, or any combination thereof.

### Nonlimiting Clauses

Clause 1: A method comprising: introducing an input brine to a first hydrate column, wherein the input brine comprises a lithium ion and water; introducing an input gas to the input brine within the first hydrate column; forming a gas hydrate with the water and the gas; concentrating the input brine, due to formation of the gas hydrate with the water, to form a concentrated brine; and extracting, from the first hydrate column, the concentrated brine.

Clause 2: The method of clause 1, further comprising: lowering the pressure to less than about 5 bar after formation of the gas hydrate; and decomposing the gas hydrate to form remaining water and remaining gas.

Clause 3: The method of clauses 1 or 2, further comprising: extracting a first majority of the remaining gas from the first hydrate column.

Clause 4: The method of any of clauses 1-3, further comprising recycling the first majority of the remaining gas from the first hydrate column to a second hydrate column; and introducing the first majority of the remaining gas as the gas within the second hydrate column.

Clause 5: The method of any of clauses 1-4, further comprising: extracting the remaining water from the first hydrate column.

Clause 6: The method of any of clauses 1-5, wherein the input brine has an initial lithium concentration, and wherein a final lithium concentration of the concentrated brine is from about 3× to about 6× of the initial lithium concentration.

Clause 7: The method of any of clauses 1-6, wherein the input gas comprises carbon dioxide.

Clause 8: The method of any of clauses 1-7, wherein introducing the input gas occurs at a pressure of about 30 bar (435.11 psi) to about 42.5 bar (616.4 psi) and at a temperature of about 5° C. to about 15° C.

Clause 9: The method of any of clauses 1-8, wherein introducing the input gas occurs in a bottom-region of the first hydrate column.

Clause 10: The method of any of clauses 1-9, wherein the first hydrate column comprises a bubble column.

Clause 11: The method of any of clauses 1-10, wherein a lithium ion concentration of the input brine is greater than about 5 ppm by weight.

Clause 12: The method of any of clauses 1-11, wherein a lithium ion concentration of the input brine is from about 5 ppm by weight to about 1,400 ppm by weight.

Clause 13: The method of any of clauses 1-12, wherein the input brine is derived from a hydrocarbon extraction operation.

Clause 14: The method of any of clauses 1-13, wherein the input brine is derived from a geothermal well.

Clause 15: The method of any of clauses 1-14, wherein a diameter to length ratio of the first hydrate column is from about 0.01 to about 1.0.

Clause 16: The method of any of clauses 1-15, wherein introducing the input brine to a first hydrate column comprises: spraying the input brine into the first hydrate column from a top-region of the first hydrate column.

Clause 17: The method of any of clauses 1-16, further comprising: introducing the input brine and remaining gas to a second hydrate column; forming a second gas hydrate from the input brine and the remaining gas within the second hydrate column; concentrating the input brine of the second hydrate column to form the concentrated brine; and extracting, from the second hydrate column, the concentrated brine.

Clause 18: The method of any of clauses 1-17, wherein the input gas comprises methane.

Clause 19: A method comprising: introducing an input brine to a first hydrate column, wherein the input brine comprises a lithium ion and water; introducing a input gas to the input brine within the hydrate column; forming a gas hydrate with the water and the gas; concentrating the input brine, due to formation of the gas hydrate with the water, to form a concentrated brine; extracting, from the first hydrate column, the concentrated brine; lowering the pressure to less than 5 bar after formation of the gas hydrate; and decomposing the gas hydrate to form remaining water and remaining gas.

Clause 20: A method comprising: introducing an input brine to a first hydrate column, wherein the first hydrate column comprises a bubble column, wherein the input brine comprises a lithium ion and water, and wherein introducing the input gas occurs at a pressure of about 30 bar (435.11 psi) to about 42.5 bar (616.4 psi) and at a temperature of about 5° C. to about 15° C.; introducing a input gas to the input brine within the first hydrate column, wherein the input gas comprises carbon dioxide; forming a gas hydrate with the water and the gas; concentrating the input brine, due to formation of the gas hydrate with the water, to form a concentrated brine; extracting, from the first hydrate column, the concentrated brine; lowering the pressure to less than 5 bar after formation of the gas hydrate; and decomposing the gas hydrate to form remaining water and remaining gas.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What claimed is:

1. A method comprising:
introducing an input brine to a first hydrate column, wherein the input brine comprises a lithium ion and water;
introducing an input gas to the input brine within the first hydrate column;
forming a gas hydrate with the water and the gas;
concentrating the input brine, due to formation of the gas hydrate with the water, to form a concentrated brine; and
extracting, from the first hydrate column, the concentrated brine.

2. The method of claim 1, further comprising:
lowering the pressure to less than about 5 bar after formation of the gas hydrate; and
decomposing the gas hydrate to form remaining water and remaining gas.

3. The method of claim 2, further comprising:
extracting a first majority of the remaining gas from the first hydrate column.

4. The method of claim 3, further comprising
recycling the first majority of the remaining gas from the first hydrate column to a second hydrate column; and
introducing the first majority of the remaining gas as the gas within the second hydrate column.

5. The method of claim 2, further comprising:
extracting the remaining water from the first hydrate column.

6. The method of claim 1, wherein the input brine has an initial lithium concentration, and wherein a final lithium concentration of the concentrated brine is from about 3× to about 6× of the initial lithium concentration.

7. The method of claim 1, wherein the input gas comprises carbon dioxide.

8. The method of claim 1, wherein introducing the input gas occurs at a pressure of about 30 bar (435.11 psi) to about 42.5 bar (616.4 psi) and at a temperature of about 5°C. to about 15°C.

9. The method of claim 1, wherein introducing the input gas occurs in a bottom-region of the first hydrate column.

10. The method of claim 1, wherein the first hydrate column comprises a bubble column.

11. The method of claim 1, wherein a lithium ion concentration of the input brine is greater than about 5 ppm by weight.

12. The method of claim 1, wherein a lithium ion concentration of the input brine is from about 5 ppm by weight to about 1,400 ppm by weight.

13. The method of claim 1, wherein the input brine is derived from a hydrocarbon extraction operation.

14. The method of claim 1, wherein the input brine is derived from a geothermal well.

15. The method of claim 1, wherein a diameter to length ratio of the first hydrate column is from about 0.01 to about 1.0.

16. The method of claim 1, wherein introducing the input brine to a first hydrate column comprises:
spraying the input brine into the first hydrate column from a top-region of the first hydrate column.

17. The method of claim 1, further comprising:
introducing the input brine and remaining gas to a second hydrate column;
forming a second gas hydrate from the input brine and the remaining gas within the second hydrate column;
concentrating the input brine of the second hydrate column to form the concentrated brine; and
extracting, from the second hydrate column, the concentrated brine.

18. The method of claim 1, wherein the input gas comprises methane.

19. A method comprising:
introducing an input brine to a first hydrate column, wherein the input brine comprises a lithium ion and water;
introducing a input gas to the input brine within the hydrate column;
forming a gas hydrate with the water and the gas;
concentrating the input brine, due to formation of the gas hydrate with the water, to form a concentrated brine;
extracting, from the first hydrate column, the concentrated brine;
lowering the pressure to less than 5 bar after formation of the gas hydrate; and
decomposing the gas hydrate to form remaining water and remaining gas.

20. A method comprising:
introducing an input brine to a first hydrate column, wherein the first hydrate column comprises a bubble column, wherein the input brine comprises a lithium ion and water, and wherein introducing the input gas occurs at a pressure of about 30 bar (435.11 psi) to about 42.5 bar (616.4 psi) and at a temperature of about 5°C. to about 15°C.;
introducing a input gas to the input brine within the first hydrate column, wherein the input gas comprises carbon dioxide;
forming a gas hydrate with the water and the gas;
concentrating the input brine, due to formation of the gas hydrate with the water, to form a concentrated brine;
extracting, from the first hydrate column, the concentrated brine;
lowering the pressure to less than 5 bar after formation of the gas hydrate; and
decomposing the gas hydrate to form remaining water and remaining gas.
